(19) United States
(12) Patent Application Publication
(10) Pub. No.: US 2015/0033746 A1
(43) Pub. Date: Feb. 5, 2015

(54) HEAT SHIELD WITH STANDOFFS

(71) Applicant: SOLAR TURBINES INCORPORATED, San Diego, CA (US)

(72) Inventors: Daniel William Carey, Sunnyvale, CA (US); Robert Anthony Corr, II, San Diego, CA (US); Crosby Hayhurst Johnson, San Diego, CA (US); Yong Weon Kim, San Diego, CA (US)

(73) Assignee: SOLAR TURBINES INCORPORATED, San Diego, CA (US)

(21) Appl. No.: 13/957,735

(22) Filed: Aug. 2, 2013

(51) Int. Cl. F02C 7/24

(52) U.S. Cl. CPC F02C 7/24
USPC 60/752; 60/722

(57) ABSTRACT

A heat shield for a combustion chamber of a gas turbine engine is disclosed. The heat shield includes a plate portion, an inner ring, and a plurality of standoffs. The plate portion includes an annular sector shape. The inner ring extends from an inner part of the plate portion. The inner ring includes a hollow cylinder shape. The plurality of standoffs extends from the plate portion, proximate outer edges of the plate portion and in the same direction as the inner ring. The plurality of standoffs forms a plurality of scallops. Each scallop is located between adjacent standoffs.

### TECHNICAL FIELD

The present disclosure generally pertains to gas turbine engines, and is more particularly directed toward a heat shield including standoffs for a gas turbine engine combustion chamber.

### BACKGROUND

Gas turbine engines include compressor, combustor, and turbine sections. The combustor includes a combustion chamber with heat shields that shield the dome plate from the combustion reaction. European Patent Application No. EP 2,489,934 discloses a combustor having a combustor liner defining a combustion chamber. The combustor may also include a liner cap disposed upstream of the combustion chamber. The liner cap may include a first plate and a second plate. Additionally, the combustor may include a fluid conduit extending between the first and second plates. The fluid conduit may be configured to receive fluid flowing adjacent to the first plate and inject the fluid into the combustion chamber.

The present disclosure is directed toward overcoming one or more of the problems discovered by the inventors or that is known in the art.

### SUMMARY OF THE DISCLOSURE

A heat shield for a combustion chamber of a gas turbine engine is disclosed. The heat shield includes a plate portion, an inner ring, and a plurality of standoffs. The plate portion includes an annular sector shape. The inner ring extends from an inner part of the plate portion. The inner ring includes a hollow cylinder shape. The plurality of standoffs extends from the plate portion, proximate outer edges of the plate portion and in the same direction as the inner ring. The plurality of standoffs forms a plurality of scallops. Each scallop is located between adjacent standoffs.

### BRIEF DESCRIPTION OF THE DRAWINGS

FIG. 1 is a schematic illustration of an exemplary gas turbine engine.

FIG. 2 is a cross-sectional view of a portion of the combustion chamber for the gas turbine engine of FIG. 1.

FIG. 3 is a detailed view of a portion the cross-section of FIG. 2.

FIG. 4 is a perspective view of a heat shield for the combustion chamber of FIG. 2.

### DETAILED DESCRIPTION

The systems and methods disclosed herein include a combustion chamber. In embodiments, the combustion chamber includes a dome plate and multiple heat shields adjacent the dome plate. Standoffs extend between the dome plate and each heat shield around the perimeter of each heat shield forming scallops there between. The standoffs and scallops may act as a flow restrictor, preventing hot combustion products from entering into the cavity between the dome plate and each heat shield.

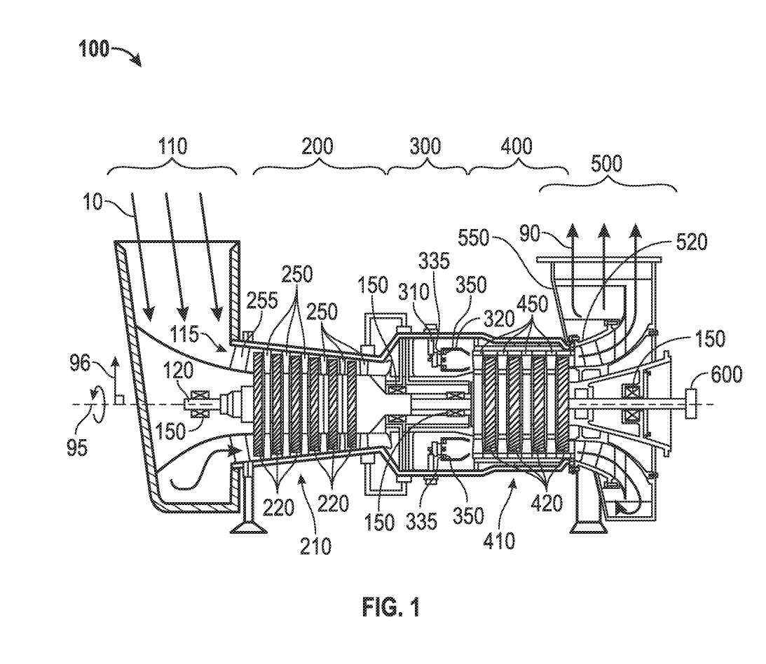

FIG. 1 is a schematic illustration of an exemplary gas turbine engine 100. Some of the surfaces have been left out or exaggerated (here and in other figures) for clarity and ease of explanation. Also, the disclosure may reference a forward and an aft direction. Generally, all references to “forward” and “aft” are associated with the flow direction of primary air (i.e., air used in the combustion process), unless specified otherwise. For example, forward is “upstream” relative to primary air flow, and aft is “downstream” relative to primary air flow.

In addition, the disclosure may generally reference a center axis 95 of rotation of the gas turbine engine, which may be generally defined by the longitudinal axis of its shaft 120 (supported by a plurality of bearing assemblies 150). The center axis 95 may be common to or shared with various other engine concentric components. All references to radial, axial, and circumferential directions and measures refer to center axis 95, unless specified otherwise, and terms such as “inner” and “outer” generally indicate a lesser or greater radial distance from, wherein a radial 96 may be in any direction perpendicular and radiating outward from center axis 95.

A gas turbine engine 100 includes an inlet 110, a shaft 120, a compressor 200, a combustor 300, a turbine 400, an exhaust 500, and a power output coupling 600. The gas turbine engine 100 may have a single shaft or a multiple shaft configuration.

The compressor 200 includes a compressor rotor assembly 210, compressor stationary vanes (stators) 250, and inlet guide vanes 255. The compressor rotor assembly 210 mechanically couples to shaft 120. As illustrated, the compressor rotor assembly 210 is an axial flow rotor assembly. The compressor rotor assembly 210 includes one or more compressor disk assemblies 220. Each compressor disk assembly 220 includes a compressor rotor disk that is circumferentially populated with compressor rotor blades. Stators 250 axially follow each of the compressor disk assemblies 220. Each compressor disk assembly 220 paired with the adjacent stators 250 that follow the compressor disk assembly 220 is considered a compressor stage. Compressor 200 includes multiple compressor stages. Inlet guide vanes 255 axially precede the compressor stages.

The combustor 300 includes one or more fuel injectors 310 and includes one or more combustion chambers 320. The fuel injectors 310 may be annularly arranged about center axis 95. In the embodiment illustrated, the combustion chamber 320 extends annularly in combustor 300. Combustion chamber 320 includes dome plate 335 at the forward end of the combustion chamber 320 adjacent fuel injectors 310. Combustion chamber 320 also includes multiple heat shields 350 adjacent dome plate 335.

The turbine 400 includes a turbine rotor assembly 410, and turbine nozzles 450. The turbine rotor assembly 410 mechanically couples to the shaft 120. As illustrated, the turbine rotor assembly 410 is an axial flow rotor assembly. The turbine rotor assembly 410 includes one or more turbine disk assemblies 420. Each turbine disk assembly 420 includes a turbine disk that is circumferentially populated with turbine blades. Turbine nozzles 450 axially precede each of the turbine disk assemblies 420. Each turbine disk assembly 420 paired with the adjacent turbine nozzles 450 that precede the turbine disk assembly 420 is considered a turbine stage. Turbine section 400 includes multiple turbine stages.

The exhaust 500 includes an exhaust diffuser 520 and an exhaust collector 550.

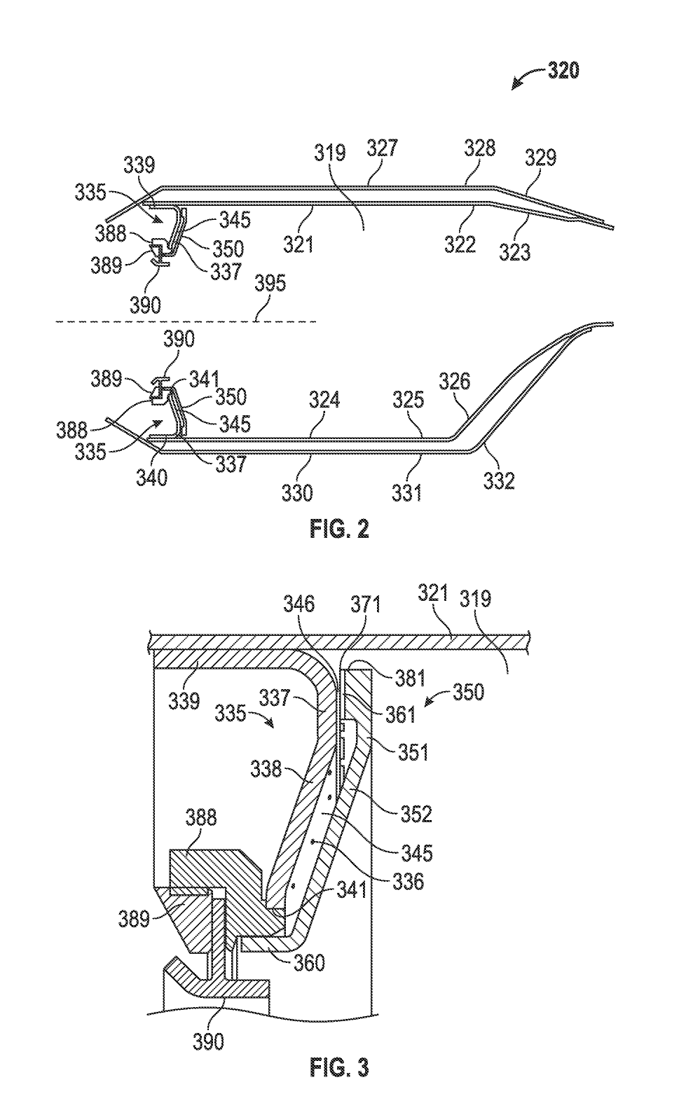

FIG. 2 is a cross-sectional view of a portion of the combustion chamber 320 for the gas turbine engine 100 of FIG. 1. FIG. 2 may not show portions of the combustion chamber 320 not present on the plane cutting through the combustion chamber 320 for clarity. Along with dome plate 335 and heat shields 350, combustion chamber 320 may also include outer liner 321 and inner liner 324. Outer liner 321 may generally include a hollow cylinder shape that defines the outer boundary of combustion chamber 320. Outer liner 321 may include outer liner forward portion 322 and outer liner aft portion 323. Outer liner forward portion 322 may be a hollow right cylinder, while outer liner aft portion 323 may be a hollow frustum of a cone with the narrower portion of the hollow frustum downstream of the wider portion.

Inner liner 324 may generally include a hollow cylinder shape that defines the inner boundary of combustion chamber 320. Inner liner 324 may be radially inward from outer liner 321 and may form an annular cavity there between. Inner liner 324 may include inner liner forward portion 325 and inner liner aft portion 326. Inner liner forward portion 325 may be a right hollow cylinder, while inner liner aft portion 326 may be a hollow frustum of a cone with the narrower portion of the hollow frustum upstream of the wider portion. The outer liner aft portion 323 and the inner liner aft portion 326 may converge, narrowing the annular cavity between outer liner 321 and inner liner 324.

In some embodiments, outer liner 321 and inner liner 324 may include cooling holes. In other embodiments, such as in some configurations for reducing formation of mono-nitrogen oxides, outer liner 321 and inner liner 324 may not include cooling holes.

Combustion chamber 320 may also include secondary outer liner 327 and secondary inner liner 330. Secondary outer liner 327 may be located radially outward from outer liner 321, forming an outer cooling cavity with an annular shape there between. Secondary outer liner 327 may include secondary outer liner forward portion 328 and secondary outer liner aft portion 329, which may be shaped similarly to outer liner forward portion 322 and outer liner aft portion 323.

Secondary inner liner 330 may be located radially inward from inner liner 324, forming an inner cooling cavity with an annular shape there between. Similar to inner liner 324, secondary inner liner 330 may include secondary inner liner forward portion 331 and secondary inner liner aft portion 332, which may be shaped similarly to inner liner forward portion 325 and inner liner aft portion 326.

Dome plate 335 includes an annular or toroidal shape. The axis of dome plate 335 may be concentric to center axis 95. Dome plate 335 may form the axial end of combustion chamber 320 where fuel and air are injected into the combustion chamber 320. Dome plate may include dome outer cylindrical portion 339, dome inner cylindrical portion 340, and dome plate portion 337. Dome outer cylindrical portion 339 may be the radially outer portion of dome plate 335 located radially inward from outer liner 321. Dome outer cylindrical portion 339 may be bonded or otherwise connected to outer liner 321. Dome inner cylindrical portion 340 may be the radially inner portion of dome plate 335 located radially outward from inner liner 324. Dome inner cylindrical portion 340 may be bonded or otherwise connected to inner liner 324. Dome outer cylindrical portion 339 and dome inner cylindrical portion 340 may each include a hollow cylinder shape.

Dome plate portion 337 includes an annular shape and extends between outer liner 321 and inner liner 324. Dome plate portion 337 may extend from dome outer cylindrical portion 339 to dome inner cylindrical portion 340. Dome plate portion 337, outer liner 321, and inner liner 324 may define combustion zone 319.

Dome plate portion 337 may include injector openings 341. Injector openings 341 may be circumferentially and evenly spaced about the axis of dome plate 335, and may be radially centered between outer liner 321 and inner liner 324 or located at the circumferential center of dome plate portion 337, concentric to an injector axis 395. In one embodiment, dome plate portion 337 includes from twelve to twenty injector openings 341. In another embodiment, dome plate portion 337 includes sixteen injector openings 341.

Combustion chamber 320 may also include a Shroud retainer 388, a floating shroud 390, and a retaining nut 389 at each injector opening 341. Each Shroud retainer 388 may be bonded or otherwise connected to dome plate 335. Each Shroud retainer 388 may be connected to dome plate 335 at an injector opening 341. A retaining nut 389 may fasten or connect to each Shroud retainer 388 and may be configured to trap a floating shroud 390 between shroud retainer 388 and retaining nut 389 while allowing relative movement of floating shroud 390 to retaining nut 389 and shroud retainer 388. Each retaining nut 389 may be a ringed or toroidal shape.

Heat shields 350 are generally located axially aft of dome plate 335. Heat shield 350 may be bonded or otherwise connected to dome plate 335. In the embodiment illustrated, heat shield 350 is bonded to dome plate 335 via bonding to Shroud retainer 388.

FIG. 3 is a detailed view of the cross-section of FIG. 2. Referring to FIGS. 2 and 3, dome plate portion 337 may include dome conical portions 338, and impingement holes 336. Dome conical portions 338 may be concentric to injector openings 341. Each dome conical portion 338 may include the shape of a frustum of a hollow cone or a funnel about an injector opening 341, with the radially smaller portion at injector opening being upstream of the radially larger portion.

Impingement holes 336 extend through dome plate portion 337. Impingement holes 336 are configured to provide cooling air between dome plate 335 and heat shields 350 and to direct cooling air at heat shields 350. Impingement holes 336 may be sized and located to control the pressure drop of cooling air across dome plate 335.

Combustion chamber 320 may include one heat shield 350 for each fuel injector 310 or injector opening 341. Each heat shield 350 includes a plate portion 351 and inner ring 360. Plate portion 351 may include conical portion 352. Conical portion 352 may include the shape of a frustum of a hollow cone or a funnel about inner ring 360. The radially smaller portion of conical portion 352 may be located at or adjoined to inner ring 360, upstream of the radially larger portion of conical portion 352.

Inner ring 360 extends from an inner part of plate portion 351 towards dome plate 335. Inner ring 360 may include a hollow cylinder shape. The hollow cylinder shape may be a right circular cylinder. When heat shield 350 is installed in gas turbine engine 100, inner ring 360 may be concentric to an injector opening 341, Shroud retainer 388, retaining nut 389, and floating shroud 390.

Heat shield 350 may include ridge 381. Ridge 381 may extend from the outer edges of plate portion 351 towards dome plate 335, in the same direction as inner ring 360. In an alternate embodiment, dome plate 335 may include ridge 381 which would then extend towards splash plate 350.

Standoffs 371 extend between dome plate 335 and heat shield 350 forming scallops 361 there between. In the embodiment illustrated, standoffs 371 extend from ridge 381. In other embodiments, standoffs 371 extend directly from plate portion 351. In yet other embodiments, standoffs 371 extend from dome plate 335 towards each heat shield 350 proximate the outer edges of plate portion 351 or aligned with ridge 381. Combustion chamber 320 may include gap 346, the space between standoffs 371 and dome plate portion 337. The nominal or cold length of gap 346 may be from ten thousandths of an inch to twenty thousandths of an inch. In one embodiment, the tolerance of the length of gap 346 is plus or minus a value less than the nominal length of gap 346. In another embodiment, the tolerance of the length of gap 346 is plus or minus the nominal length of gap 346.

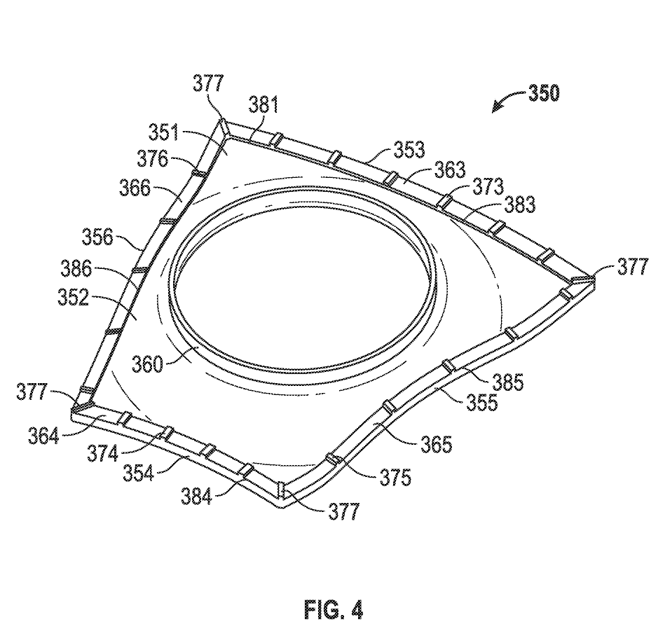

FIG. 4 is a perspective view of a heat shield 350 for the combustion chamber 320 of FIG. 2. Referring to FIG. 4, heat shield 350 may include an annular sector shape. The angle of the annular sector may be from eighteen to thirty degrees. Heat shield 350 includes outer edge 353, inner edge 354, first radial edge 355, second radial edge 356, and multiple standoffs 371. Outer edge 353 may include a concave arced shape. Outer edge 353 may be concentric to dome plate 335 and outer liner 321. Inner edge 354 may include a convex arced shape and may be concentric to outer edge 353, located radially inward from outer edge 353 relative to the center of outer edge 353.

First radial edge 355 spans from outer edge 353 to inner edge 354 along a radial line extending from the center of outer edge 353. Second radial edge 356 also spans from outer edge 353 to inner edge 354 along a radial line extending from the center of outer edge 353. First radial edge 355 and second radial edge 356 may be angularly spaced from eighteen to thirty degrees.

In the embodiment illustrated, ridge 381 spans completely around the edges of plate portion 351 and includes an outer ridge 383, an inner ridge 384, a first radial ridge 385, and a second radial ridge 386. Ridge 381 may vary in in width from one-eighth of an inch to three-eighths of an inch, and may vary in height. Outer ridge 383 extends from plate portion 351 adjacent outer edge 353 and spanning along outer edge 353. Inner ridge 384 extends from plate portion 351 adjacent inner edge 354 and spanning along inner edge 354. First radial ridge 385 extends from plate portion 351 adjacent first radial edge 355 and spanning along first radial edge 355. Second radial ridge 386 extends from plate portion 351 adjacent second radial edge 356 and spanning along second radial edge 356.

In the embodiment illustrated, heat shield 350 includes outer edge standoffs 373, inner edge standoffs 374, first radial edge standoffs 375, and second radial edge standoffs 376. As illustrated, outer edge standoffs 373 extend from outer ridge 383 forming outer edge scallops 363 there between. Outer edge standoffs 373 may be evenly spaced along outer ridge 383. Outer edge standoffs 373 may be uniformly sized and may form uniformly sized outer edge scallops 363. Heat shield 350 may include from four to eight outer edge standoffs 373. In the embodiment illustrated, the length of each outer edge standoff 373 is from one-sixteenth of an inch to three-sixteenth of an inch in length in the direction of outer edge 353. In another embodiment, the length of each outer edge standoff 373 may be from one-sixteenth of an inch to three-quarters of an inch. In yet another embodiment, the length of each outer edge standoff 373 is from one-quarter of an inch to one-half of an inch.

Heat shield 350 may include from five to nine outer edge scallops 363. In the embodiment illustrated, the length of each outer edge scallop 363 is from seven-eighths of an inch to one and one-eighth inches. In another embodiment, the length of each outer edge scallop 363 is from one-quarter of an inch to one and one-eighth inches. In yet another embodiment, the length of each outer edge scallop 363 is from one-quarter of an inch to one-half of an inch.

In the embodiment illustrated, the height of outer edge standoffs 373 and the depth of outer edge scallops 363 are from fifteen thousandths of an inch to sixty thousandths of an inch. In another embodiment, the height of outer edge standoffs 373 and the depth of outer edge scallops 363 are from fifty thousandths of an inch to sixty thousandths of an inch.

As illustrated, inner edge standoffs 374 extend from inner ridge 384 forming inner edge scallops 364 there between. Inner edge standoffs 374 may be evenly spaced along inner ridge 384. Inner edge standoffs 374 may be uniformly sized and may form uniformly sized inner edge scallops 364. Heat shield 350 may include from three to six inner edge standoffs 374. In the embodiment illustrated, the length of each inner edge standoff 374 is from one-sixteenth of an inch to three-sixteenth of an inch in length in the direction of inner edge 354. In another embodiment, the length of each inner edge standoff 374 may be from one-sixteenth of an inch to three-quarters of an inch. In yet another embodiment, the length of each inner edge standoff 374 is from one-quarter of an inch to one-half of an inch.

Heat shield 350 may include from four to seven inner edge scallops 364. In the embodiment illustrated, the length of each inner edge scallop 364 is from five-eighths of an inch to three-quarters of an inch. In another embodiment, the length of each inner edge scallop 364 is from one-eighth of an inch to three-quarters of an inch. In yet another embodiment, the length of each inner edge scallop 364 is from one-eighth of an inch to one-half of an inch.

In the embodiment illustrated, the height of inner edge standoffs 374 and the depth of inner edge scallops 364 are from fifteen thousandths of an inch to sixty thousandths of an inch. In another embodiment, the height of inner edge standoffs 374 and the depth of inner edge scallops 364 are from fifty thousandths of an inch to sixty thousandths of an inch.

As illustrated, first radial edge standoffs 375 extend from first radial ridge 385 forming first radial edge scallops 365 there between. First radial edge standoffs 375 may be evenly spaced along first radial ridge 385. First radial edge standoffs 375 may be uniformly sized and may form uniformly sized first radial edge scallops 365. Heat shield 350 may include from four to seven first radial edge standoffs 375. In the embodiment illustrated, the length of each first radial edge standoff 375 is from one-sixteenth of an inch to three-sixteenth of an inch in length in the direction of first radial edge 355. In another embodiment, the length of each first radial edge standoff 375 may be from one-sixteenth of an inch to three-quarters of an inch. In yet another embodiment, the length of each first radial edge standoff 375 is from five-eighths of an inch to three-quarters of an inch.

Heat shield 350 may include from four to seven first radial edge scallops 365. In the embodiment illustrated, the length of four first radial edge scallops 365 are from one and three-eighths inches to one and five-eighths inches with the length of a fifth first radial edge scallop 365 from one-quarter of an inch to one-half of an inch. In another embodiment, the length of each first radial edge scallop 365 is from one-eighth of an inch to one and five-eighths inches. In yet another embodiment, the length of each first radial edge scallop 365 is from five-eighths of an inch to three-quarters of an inch.

In the embodiment illustrated, the height of first radial edge standoffs 375 and the depth of first radial edge scallops 365 are from fifteen thousandths of an inch to sixty thousandths of an inch. In another embodiment, the height of first radial edge standoffs 375 and the depth of first radial edge scallops 365 are from fifteen thousandths of an inch to twenty-five thousandths of an inch.

As illustrated, second radial edge standoffs 376 extend from second radial ridge 386 forming second radial edge scallops 366 there between. Second radial edge standoffs 376 may be evenly spaced along second radial ridge 386. Second radial edge standoffs 376 may be uniformly sized and may form uniformly sized second radial edge scallops 366. Heat shield 350 may include from four to seven second radial edge standoffs 376. In the embodiment illustrated, the length of each second radial edge standoff 376 is from one-sixteenth of an inch to three-sixteenth of an inch in length in the direction of second radial edge 356. In another embodiment, the length of each second radial edge standoff 376 may be from one-sixteenth of an inch to three-quarters of an inch. In yet another embodiment, the length of each second radial edge standoff 376 is from five-eighths of an inch to three-quarters of an inch.

Heat shield 350 may include from four to seven second radial edge scallops 366. In the embodiment illustrated, the length of four second radial edge scallops 366 are from one and three-eighths inches to one and five-eighths inches with the length of a fifth second radial edge scallop 366 from one-quarter of an inch to one-half of an inch. The shorter second radial edge scallop 366 may be located radially opposite as the shorter first radial edge scallop 365 so as to locate the remaining first radial scallops 365 and second radial scallops 366 in alternating locations. In another embodiment, the length of each second radial edge scallop 366 is from one-eighth of an inch to one and five-eighths inches. In yet another embodiment, the length of each second radial edge scallop 366 is from five-eighths of an inch to three-quarters of an inch.

In the embodiment illustrated the height of second radial edge standoffs 376 and the depth of second radial edge scallops 366 are from fifteen thousandths of an inch to sixty thousandths of an inch. In another embodiment, the height of second radial edge standoffs 376 and the depth of second radial edge scallops 366 are from fifteen thousandths of an inch to twenty-five thousandths of an inch.

Heat shield 350 may also include corner standoffs 377. Corner standoffs 377 may extend from ridge 381 at the corners where outer edge ridge 383 or inner edge ridge 384 intersect first radial edge ridge 385 or second radial edge ridge 386.

In the embodiment illustrated, first radial edge standoffs 375 and second radial edge standoffs 376 are cuboids, and outer edge standoffs 373 and inner edge standoffs 374 are segments of an annular solid or ring cut by parallel planes. Standoffs 371 may also be, inter alia, cubes, prisms, cylinders, or portions of a hollow cylinder.

Scallops 361 may be sized to control the total flow area between each heat shield 350 and dome plate 335. The flow area for a scallop 361 may be the height of an adjacent standoff 371 times the length of the scallop 361 along an edge of the heat shield 350. The total flow area may also include the area defined by the length of the edges of heat shield 350 times gap 346. In one embodiment, the nominal or cold total flow area is from 0.225 inches squared to 0.650 inches squared. In another embodiment, the nominal total flow area is from 0.250 inches squared to 0.260 inches squared. In yet another embodiment, the nominal total flow area is from 0.545 inches squared to 0.550 inches squared. In a further embodiment, the nominal total flow area is from 0.770 inches squared to 0.780 inches squared.

The size and orientation of the standoffs 371 and the scallops 361, and the total flow area may determine the pressure drop across the scallops 361 from cavity 345 to combustion zone 319. In one embodiment, standoffs 371 and scallops 361 are configured to produce a static pressure drop of at least one half of a static pressure variation inside the combustion chamber 320. In one embodiment, standoffs 371 and scallops 361 are configured to produce a pressure drop of at least 0.4 pounds per square inch (psi). In another embodiment, standoffs 371 and scallops 361 are configured to produce a pressure drop from 0.4 psi to 1.3 psi. In yet another embodiment, standoffs 371 and scallops 361 are configured to produce a pressure drop from 0.6 psi to 0.8 psi.

The pressure drop across impingement holes 336 and into cavity 345 may be determined by the size and orientation of impingement holes 336. In one embodiment, the pressure drop across impingement holes is at least 4.0 psi. In another embodiment, the pressure drop across impingement holes is from 4.0 psi to 6.0 psi. In yet another embodiment, the pressure drop across impingement holes is from 4.5 psi to 5.5 psi.

One or more of the above components (or their subcomponents) may be made from stainless steel and/or durable, high temperature materials known as “superalloys”. A superalloy, or high-performance alloy, is an alloy that exhibits excellent mechanical strength and creep resistance at high temperatures, good surface stability, and corrosion and oxidation resistance. Superalloys may include materials such as HASTELLOY, alloy x, INCONEL, WASPALOY, RENE alloys, HAYNES alloys, alloy 188, alloy 230, INCOLOY, MP98T, TMS alloys, and CMSX single crystal alloys. In one embodiment, heat shield 350 includes HAYNES 230. In another embodiment, heat shield 350 includes HASTELLOY X. In yet another embodiment, heat shield 350 includes INCONEL 625.

### INDUSTRIAL APPLICABILITY

Gas turbine engines may be suited for any number of industrial applications such as various aspects of the oil and gas industry (including transmission, gathering, storage, withdrawal, and lifting of oil and natural gas), the power generation industry, cogeneration, aerospace, and other transportation industries.

Referring to FIG. 1, a gas (typically air 10) enters the inlet 110 as a “working fluid”, and is compressed by the compressor 200. In the compressor 200, the working fluid is compressed in an annular flow path 115 by the series of compressor disk assemblies 220. In particular, the air 10 is compressed in numbered “stages”, the stages being associated with each compressor disk assembly 220. For example, “4th stage air” may be associated with the 4th compressor disk assembly 220 in the downstream or “aft” direction, going from the inlet 110 towards the exhaust 500). Likewise, each turbine disk assembly 420 may be associated with a numbered stage.

Once compressed air 10 leaves the compressor 200, it enters the combustor 300, where it is diffused and fuel is added. Air 10 and fuel are injected into the combustion chamber 320 via fuel injector 310 and ignited. After the combustion reaction, energy is then extracted from the combusted fuel/air mixture via the turbine 400 by each stage of the series of turbine disk assemblies 420. Exhaust gas 90 may then be diffused in exhaust diffuser 520 and collected, redirected, and exit the system via an exhaust collector 550. Exhaust gas 90 may also be further processed (e.g., to reduce harmful emissions, and/or to recover heat from the exhaust gas 90).

Operating efficiency of a gas turbine engine generally increases with a higher combustion temperature. Thus, there is a trend in gas turbine engines to increase the temperatures. The temperatures in the combustion chamber 320 may be 1000 degrees Fahrenheit or more. To operate at such high temperatures a portion of the compressed air 10 from the compressor 200, cooling air, may be diverted through internal passages or chambers to cool various components of a gas turbine engine 100 including the heat shields 350 of the combustion chamber 320.

Cooling air may be directed through a dome plate 335 to cool the heat shields 350 and to act as a buffer to prevent hot combustion gases from ingressing into the cavity 345 between the dome plate 335 and each heat shield 350. The amount of air required to act as a buffer may require significantly more air than the amount of air required to cool the heat shields 350. Use of the cooling air may reduce the operating efficiency of the gas turbine engine and may negatively affect the combustion process as the buffer air enters the combustion zone 319. For example, in configurations for reducing formation of mono-nitrogen oxides, excess air, such as the buffer air, may interfere with the flame holding of the leaner air and fuel mixture and may reduce the reliability of the gas turbine engine.

The combustion process may produce pressure variations within the combustion zone 319. The higher pressures may cause combustion products to ingress into the cavity 345 behind a heat shield 350. Such ingress of combustion products may damage or reduce the operating life of the heat shields 350 and dome plate 335.

Standoffs 371 and scallops 361 located between dome plate 335 and each heat shield 350 about the perimeter or boundary of each heat shield 350 may act as a flow restrictor. The flow restriction may create a pressure drop across the boundary of each heat shield 350. The pressure in the cavity 345 behind each heat shield 350 may be greater than the highest pressure in the combustion zone 319.

The higher pressure behind the heat shields 350 may prevent or reduce the ingress of hot combustion products or gases and may reduce the amount of cooling air required to act as a buffer. Preventing or reducing the ingress of hot combustion products into the cavity 345 behind the heat shields 350 may prevent damage to the heat shields 350 and the dome plate 335, and may increase the operating life of the heat shields 350 and the dome plate 335.

With the higher pressure behind the heat shields 350, the amount of cooling air required to cool the heat shields 350 may be sufficient to act as a buffer to prevent the ingress of combustion products. Such a reduction in cooling air used may, inter alia, increase the efficiency of gas turbine engine 100 and improve the combustion processes. For example, less cooling air entering the combustion zone 319 may stabilize the flame and improve flame holding.

The preceding detailed description is merely exemplary in nature and is not intended to limit the invention or the application and uses of the invention. The described embodiments are not limited to use in conjunction with a particular type of gas turbine engine. Hence, although the present disclosure, for convenience of explanation, depicts and describes a particular heat shield, it will be appreciated that the heat shield in accordance with this disclosure can be implemented in various other configurations, can be used with various other types of gas turbine engines, and can be used in other types of machines. Furthermore, there is no intention to be bound by any theory presented in the preceding background or detailed description. It is also understood that the illustrations may include exaggerated dimensions to better illustrate the referenced items shown, and are not consider limiting unless expressly stated as such.

What is claimed is:

1. A heat shield for a combustion chamber of a gas turbine engine, the heat shield comprising:
a plate portion including an annular sector shape and outer edges extending about the annular sector shape;
an inner ring extending from an inner part of the plate portion, the inner ring including a hollow cylinder shape; and
a plurality of standoffs proximate the outer edges of the plate portion and extending from the plate portion in the same direction as the inner ring, the plurality of standoffs forming a plurality of scallops, each scallop being located between adjacent standoffs.

2. The heat shield of claim 1, wherein the plate portion includes a ridge extending in the same direction as the inner ring, located adjacent the outer edges of the plate portion with the plurality of standoffs extending from the ridge.

3. The heat shield of claim 1, wherein a total flow area including a flow area of each scallop of the plurality of scallops, the flow area of each scallop defined by the height of one of the plurality of standoffs adjacent the scallop times the length of the scallop along the edge of the heat shield is from 0.225 inches squared to 0.650 inches squared.

4. The heat shield of claim 1, wherein a total flow area including a flow area of each scallop of the plurality of scallops, the flow area of each scallop defined by the height of one of the plurality of standoffs adjacent the scallop times the length of the scallop along the edge of the heat shield is from 0.250 inches squared to 0.260 inches squared.

5. The heat shield of claim 2, wherein a total flow area including a flow area of each scallop of the plurality of scallops, the flow area of each scallop defined by the height of one of the plurality of standoffs adjacent the scallop times the length of the scallop along the edge of the heat shield and an area defined by the length of the edges of the heat shield times a gap between the standoffs and a dome plate for a combustor is from 0.225 inches squared to 0.650 inches squared.

6. The heat shield of claim 1, wherein the plurality of standoffs and the plurality of scallops are configured to produce a pressure drop of at least 0.4 pounds per square inch.

7. The heat shield of claim 1, wherein the plurality of standoffs and the plurality of scallops are configured to produce a static pressure drop of at least one half of a static pressure variation inside the combustion chamber.

8. A heat shield for a combustion chamber of a gas turbine engine, the heat shield comprising:
A plate portion including
an outer edge including a concave arced shape,
an inner edge including a convex arced shape, the inner edge being concentric and located opposite the outer edge,
a first radial edge spanning from the outer edge to the inner edge along a radial line extending from the center of the outer edge, and
a second radial edge spanning from the outer edge to the inner edge along a radial line extending from the center of the outer edge and angularly spaced from the first radial edge from eighteen to thirty degrees;
a conical portion including the shape of a frustum of a hollow cone;
an inner ring extending from the conical portion at a portion of the frustum with a smaller radius, the inner ring including a hollow cylinder shape extending in the same axial direction as the conical portion;
a ridge extending from the plate portion in the same direction as the inner ring, the ridge including
an outer ridge spanning along the outer edge,
an inner ridge spanning along the inner edge,
a first radial ridge spanning along the first radial edge, and
a second radial ridge spanning along the second radial edge;
a plurality of outer edge standoffs extending from the outer ridge and forming outer edge scallops between adjacent outer edge standoffs;
a plurality of inner edge standoffs from the inner ridge and forming inner edge scallops between adjacent inner edge standoffs;
a plurality of first radial edge standoffs extending from the first radial ridge and forming first radial edge scallops between adjacent first radial edge standoffs; and
a plurality of second radial edge standoffs from the second radial ridge and forming second radial edge scallops between adjacent second radial edge standoffs.

9. The heat shield of claim 8, wherein the plurality of outer edge standoffs includes from four to eight outer edge standoffs, the plurality of inner edge standoffs includes from three to six inner edge standoffs, the plurality of first radial edge standoffs includes from four to seven first radial edge standoffs, and the plurality of second radial edge standoffs includes from four to seven second radial edge standoffs.

10. The heat shield of claim 9, wherein each outer edge standoff is from one-quarter of an inch to one and one-fourths of an inch, the length of each inner edge standoff is from one-sixteenth of an inch to three-quarters of an inch, the length of each first radial edge standoff is from one-sixteenth of an inch to three-quarters of an inch, and the length of each second radial edge standoff is from one-sixteenth of an inch to three-quarters of an inch.

11. The heat shield of claim 8, wherein a total nominal flow area including the nominal flow area of each outer edge scallop defined by the height of the plurality of outer edge scallops times the length of the outer edge scallop, the nominal flow area of each inner edge scallop defined by the height of the plurality of inner edge scallops times the length of the inner edge scallop, the nominal flow area of each first radial edge scallop defined by the height of the plurality of first radial edge standoffs times the length of the first radial edge scallop, and the nominal flow area of each second radial edge scallop defined by the height of the plurality of second radial edge standoffs times the length of the second radial each scallop is from 0.225 inches squared to 0.650 inches squared.

12. The heat shield of claim 8, wherein the ridge, the plurality of outer edge standoffs, the plurality of inner edge standoffs, the plurality of first radial edge standoffs, the plurality of second radial edge standoffs, the outer edge scallops, the inner edge scallops, the first radial edge scallops, and the second radial edge scallops are configured to produce a pressure drop of at least 0.4 pounds per square inch.

13. The heat shield of claim 8, wherein the ridge, the plurality of outer edge standoffs, the plurality of inner edge standoffs, the plurality of first radial edge standoffs, the plurality of second radial edge standoffs, the outer edge scallops, the inner edge scallops, the first radial edge scallops, and the second radial edge scallops are configured to produce a pressure drop from 0.4 pounds per square inch to 1.3 pounds per square inch.

14. The heat shield of claim 8, wherein the plurality of outer edge standoffs each include a shape of a segment of an annular solid, the plurality of inner edge standoffs each include a shape of a segment of an annular solid, the plurality of first radial edge standoffs each include a cuboid shape, and the plurality of second radial edge standoffs each include a cuboid shape.

15. A combustion chamber of a gas turbine engine, the combustion chamber comprising:
an outer liner;
an inner liner located radially inward from the outer liner;
a dome plate extending between an end of the outer liner and an end of the inner liner, the dome plate including a dome plate portion with an annular disk shape, the dome plate portion including
injector openings circumferentially spaced about an axis of the dome plate;
a plurality of heat shields adjacent the dome plate extending between the outer liner and the inner liner, each heat shield including
a plate portion including, and
an inner ring extending from the plate portion towards the dome plate and being connected to the dome plate at one of the injector openings, the inner ring including a hollow cylinder shape; and
a plurality of standoffs extending between the dome plate and each of the plurality of heat shields about the perimeter of each heat shield, the plurality of standoffs forming a plurality of scallops there;
wherein the dome plate includes a plurality of impingement holes adjacent each heat shield configured to direct air at the heat shield.

16. The combustion chamber of claim 15, wherein the plurality of standoffs is connected to each plate portion proximate the perimeter of the plate portion.

17. The combustion chamber of claim 15, wherein the plurality of standoffs is connected to the dome plate.

18. The combustion chamber of claim 15, wherein the dome plate, each heat shield, and the standoffs extending there between form a cavity and the plurality of heat shields, the outer liner and the inner liner form a combustion zone, and each plurality of impingement holes is configured to produce at least a 4.0 pounds per square inch pressure drop as air enters the cavity and the plurality of scallops are configured to produce at least a 0.4 pounds per square inch pressure drop as air leaves the cavity and enters the combustion zone.

19. The combustion chamber of claim 15, wherein a total flow area including a flow area of each scallop, between one of the plurality of heat shields and the dome plate, the flow area of each scallop defined by the height of an adjacent standoff times the length of the scallop along the edge of the heat shield is from 0.225 inches squared to 0.650 inches squared.

20. A gas turbine engine including the combustion chamber of claim 15, wherein the outer liner, the inner liner, and the dome plate are concentric to a shaft of the gas turbine engine.
